(19) United States
(12) Patent Application Publication
(10) Pub. No.: US 2021/0213961 A1
(43) Pub. Date: Jul. 15, 2021

(54) DRIVING SCENE UNDERSTANDING

(71) Applicant: Beijing Sankuai Online Technology Co., Ltd, Beijing (CN)

(72) Inventors: Shuguang DING, Beijing (CN); Yuexiang JIN, Beijing (CN); Mingyu FAN, Beijing (CN); Dongchun REN, Beijing (CN)

(21) Appl. No.: 16/950,913

(22) Filed: Nov. 18, 2020

(30) Foreign Application Priority Data
Jan. 15, 2020 (CN) 202010039506.9

(51) Int. Cl. B60W 40/09; B60W 30/095; B60W 40/06; B60W 60/00; G01C 21/34; G01C 21/36; G06N 3/08; G06N 3/04

(52) U.S. Cl. CPC B60W 40/09; B60W 30/0956; B60W 40/06; B60W 60/0015; B60W 2040/0872; G01C 21/3484; G01C 21/3691; G06N 3/08; G06N 3/04; B60W 60/0013

(57) ABSTRACT

Various embodiments provide a driving scene understanding method and apparatus, and a track planning method and apparatus. In various embodiments, a stress driving behavior of a human driver is identified; a class of the identified stress driving behavior is determined; at least one target is determined according to the identified stress driving behavior, the class of the stress driving behavior and driving scene information corresponding to the stress driving behavior. In those embodiments, where the driving scene information includes at least one of the following: a reference track, an actual traveling track, static obstacle information, dynamic obstacle information, and road information. Driving scene understanding can be performed according to the determined at least one target.

### CROSS-REFERENCE TO RELATED APPLICATIONS

This application claims priority to Chinese Patent Application No. 202010039506.9 filed on Jan. 15, 2020, the disclosure of which is incorporated herein by reference in its entirety.

### TECHNICAL FIELD

The present disclosure relates to the field of scene understanding, and in particular to a driving scene understanding method and device, a storage medium, and a track planning method.

### BACKGROUND

Scene understanding mainly relates to target search, detection, scene segmentation and the like in a driving scene, and plays an important role in implementing self-driving of a self-driving device. Scene perception data from a plurality of sensors may be converted into a decision basis of a voluntary movement. The self-driving device may make a behavior decision, local movement planning and the like based on the scene understanding, thereby implementing autonomous intelligent driving of the self-driving device.

### SUMMARY

Various embodiments provide a driving scene understanding method and device, a storage medium, and a track planning method.

According to an aspect in accordance with the present disclosure, a driving scene understanding method is provided, and applied to a neural network, the driving scene method is implemented by a processor in a self-driving device such that the processor is caused to perform the following operations: identifying a stress driving behavior of a human driver; determining a class of the identified stress driving behavior; determining at least one target according to the identified stress driving behavior, the class of the stress driving behavior and driving scene information corresponding to the stress driving behavior, where the driving scene information includes at least one of the following: a reference track, an actual traveling track, static obstacle information, dynamic obstacle information, and road information; and performing driving scene understanding according to the determined at least one target.

In some embodiments, identifying the stress driving behavior of a human driver includes:

obtaining driving behavior data of the human driver having a time series, where the driving behavior data includes a velocity of a driving device and a steering angle of a steering wheel of the driving device; and

searching, by using a search network in the neural network, the driving behavior data for partial driving behavior data having a first feature as stress driving behavior data.

In some embodiments, the first feature includes features regarding variations in the velocity and the steering angle of the driving device.

In some embodiments, determining the class of the identified stress driving behavior includes:

identifying a second feature of the stress driving behavior data by using a classification network in the neural network, and marking the stress driving behavior data with a class label according to the identified second feature, where

the class label indicates one of the following stress driving behaviors: stopping, car-following, overtaking and avoiding.

In some embodiments, the second feature includes features regarding variation trend in the velocity and the steering angle of the driving device.

In some embodiments, determining the at least one target according to the identified stress driving behavior, the class of the stress driving behavior and driving scene information corresponding to the stress driving behavior includes:

performing, according to the class of the stress driving behavior, attention processing on the stress driving behavior by using an attention network in the neural network;

determining the at least one target based on the stress driving behavior on which the attention processing is performed and the driving scene information corresponding to the stress driving behavior, and performing a safe distance identification on each of the at least one target by using a responsibility sensitive safety circuit; and

for a target corresponding to a safe distance less than a preset value, marking the target with an attention label.

In some embodiments, performing, according to the class of the stress driving behavior, the attention processing on the stress driving behavior by using the attention network includes at least one of the following:

for a stress driving behavior of a stopping class, detecting whether a traffic light exists in a traveling direction of the driving device, where

in response to that a traffic light exists, determining the traffic light as the target and marking the traffic light with the attention label; and in response to detecting that no traffic light exists, paying attention around the driving device.

In some embodiments, the method further includes: for a stress driving behavior of an overtaking class, paying attention in front of and beside the driving device; for a stress driving behavior of a car-following class, paying attention in front of the driving device; and for a stress driving behavior of an avoiding class, paying attention in front of, behind and beside the driving device.

In some embodiments, the driving scene information includes at least image frame information, and the performing driving scene understanding according to the determined at least one target includes:

for each of the at least one target, extracting an image feature corresponding to the target by performing convolution processing on a plurality of image frames related to the target with a convolutional neural network (CNN) in the neural network;

allocating, based on the image feature, a weight to each of the image frames with a long short-term memory (LSTM) network in the neural network;

capturing, according to each of the image frames to which the weight is allocated, an action feature of the target with an optical flow method; and

determining, based on the action feature of the target, semantic description information of the target as a driving scene understanding result.

According to another aspect in accordance with the present disclosure, a track planning method is provided, and applied to a track planning module of a self-driving device, the method including:

obtaining driving scene information, where the driving scene information includes at least one of the following: a reference track, an actual traveling track, static obstacle information, dynamic obstacle information, and road information; and

performing track planning by using a track planning model and the obtained driving scene information, where training data used by the track planning model is classified and/or marked with a driving scene understanding result obtained by using any driving scene understanding method described above.

According to still another aspect in accordance with the present disclosure, a driving scene understanding apparatus is provided, the apparatus including:

an identifying unit, configured to identify a stress driving behavior of a human driver; and

an understanding unit, configured to determine a class of the identified stress driving behavior; determine at least one target according to the identified stress driving behavior, the class of the stress driving behavior and driving scene information corresponding to the stress driving behavior, where the driving scene information includes at least one of the following: a reference track, an actual traveling track, static obstacle information, dynamic obstacle information, and road information; and perform driving scene understanding according to the determined at least one target.

In some embodiments, the identifying unit is configured to obtain driving behavior data of the human driver in a time sequence, where the driving behavior data includes a velocity of a driving device and a steering angle of the driving device; and search, by using a search network in the neural network, the driving behavior data for partial driving behavior data having a first feature as stress driving behavior data.

In some embodiments, the first feature includes features regarding variation in the velocity and the steering angle of the driving device.

In some embodiments, the understanding unit is configured to identify a second feature of the stress driving behavior data by using a classification network in the neural network, and mark the stress driving behavior data with a class label according to the identified second feature, where the class label indicates one of the following stress driving behaviors: stopping, car-following, overtaking and avoiding.

In some embodiments, the second feature includes features regarding variation trend in the velocity and the steering angle of the driving device.

In some embodiments, the understanding unit is configured to perform, according to the class of the stress driving behavior, attention processing on the stress driving behavior by using an attention network in the neural network; determine the at least one target based on the stress driving behavior on which the attention processing is performed and the driving scene information corresponding to the stress driving behavior, and perform a safe distance identification on each of the at least one target by using a responsibility sensitive safety circuit; and for a target corresponding to a safe distance less than a preset value, mark the target with an attention label.

In some embodiments, the understanding unit is configured to, for a stress driving behavior of a stopping class, detect whether a traffic light exists in a traveling direction of the driving device, where in response to that a traffic light exists, determine the traffic light as the target and mark the traffic light with the attention label; and in response to detecting that no traffic light exists, pay attention around the driving device; for a stress driving behavior of an overtaking class, pay attention in front of and beside the driving device; for a stress driving behavior of a car-following class, pay attention in front of the driving device; and for a stress driving behavior of an avoiding class, pay attention behind and beside the driving device.

In some embodiments, the driving scene information includes at least information in an image frame form, and the understanding unit is configured to: for each of the at least one target, extract an image feature corresponding to the target by performing convolution processing on a plurality of image frames related to the target with a convolutional neural network in the neural network; allocate based on the image feature, a weight to each of the image frames with a long short-term memory network in the neural network, and capture, according to each of the image frames to which the weight is allocated, an action feature of the target with an optical flow method; and determine, based on the action feature of the target, semantic description information of the target as a driving scene understanding result.

According to yet another aspect of the present disclosure, a track planning apparatus is provided, and applied to a track planning module of a self-driving device, the apparatus including:

an obtaining unit, configured to obtain driving scene information, where the driving scene information includes at least one of the following: a reference track, an actual traveling track, static obstacle information, dynamic obstacle information, and road information; and

a model unit, configured to perform track planning by using a track planning model and the obtained driving scene information, where training data used by the track planning model is classified and/or marked with a driving scene understanding result obtained by using any driving scene understanding apparatus described above.

According to still yet another aspect of the present disclosure, an electronic device is provided, including: a processor; and a memory storing instructions executable to the processor, where when the instructions are executed, the processor is caused to implement any driving scene understanding method or track planning method for a self-driving device described above.

According to a further aspect of the present disclosure, a non-transitory computer-readable storage medium is provided, and stores computer-readable program code, where when the computer-readable program code is executed by a processor, the processor is caused to implement any driving scene understanding method or track planning method for a self-driving device described above.

It can be known from the above description that, according to embodiments of the present disclosure, the concept of stress is introduced into scene understanding. Therefore, in a driving scene understanding process, effective learning is performed based on manipulation of a human driver for a driving device, a stress driving behavior is identified and analyzed and a corresponding target is marked, thereby improving a scene understanding level of a self-driving device for a driving scene, facilitating track planning of the self-driving device, and ensuring smooth and safe traveling.

The foregoing description is merely an overview of various embodiments in accordance with the present disclosure. To understand the present disclosure more clearly, implementation can be performed according to content of the specification. Moreover, to make the foregoing and other objectives, features, and advantages of the present disclosure more comprehensible, specific implementations of the present disclosure are particularly listed below.

### BRIEF DESCRIPTION OF THE DRAWINGS

FIG. 1 is a schematic flowchart of a driving scene understanding method according to an embodiment of the present disclosure.

FIG. 2 is a schematic flowchart of a track planning method according to an embodiment of the present disclosure.

FIG. 3 is a schematic structural diagram of a driving scene understanding apparatus according to an embodiment of the present disclosure.

FIG. 4 is a schematic structural diagram of a track planning apparatus according to an embodiment of the present disclosure.

FIG. 5 is a schematic structural diagram of a driving scene understanding network framework according to an embodiment of the present disclosure.

FIG. 6 is a schematic structural diagram of an electronic device according to an embodiment of the present disclosure.

FIG. 7 is a schematic structural diagram of a computer-readable storage medium according to an embodiment of the present disclosure.

### DETAILED DESCRIPTION OF THE EMBODIMENTS

The following describes in detail exemplary embodiments in accordance with the present disclosure with reference to the accompanying drawings. Although the accompanying drawings show the exemplary embodiments in accordance with the present disclosure, it should be understood that the present disclosure may be implemented in various manners and is not limited by the embodiments described herein. Rather, these embodiments are provided, so that the present disclosure is more thoroughly understood and the scope of the present disclosure is completely conveyed to a person skilled in the art.

In usual scene understanding, an effective target (for example, a person, an object or an obstacle) cannot be marked. Consequently, marking costs are excessively high, an algorithm is excessively complex, and a scene understanding difficulty is large. When the driving scene understanding problem is to be resolved, the following manners have been tried.

In a manner, to implement automated scene understanding, a target around a self-driving device may be marked and analyzed. However, in this manner, many useless targets or targets affecting no driving behavior of the self-driving device are marked in a marking process. For example, pedestrians in a sidewalk traveling in the same direction as that of a driving device may be marked.

In another manner, a driving behavior decision in a driving video of a self-driving device may be understood with reference to traffic regulations. However, in this manner, it is likely that scene understanding cannot be performed based on a purely logicalized rule under an actual complex road condition.

In still another manner, a target to which attention is paid in a driving process of a human driver may be marked manually through self-driving scene understanding based on an attention mechanism, so that a self-driving device understands a scene based on a concerning manner of the human driver. However, in this manner, the field of view of the human driver has limitations, sensor performance of the self-driving device cannot be maximized, and costs of manual marking are excessively large.

With reference to the foregoing analysis, the present disclosure provides scene understanding for a self-driving device. By analyzing a stress driving behavior of a human driver such as stopping, car-following, or avoiding, and marking only a target (reason) causing the behavior, complexity of a target marking algorithm may be notably reduced. A scene may be understood according to a driving behavior, and the self-driving device is not limited by an excessively logicalized rule, and has relatively good robustness in a case of facing a complex road. When a stress driving behavior occurs, the behavior may be classified, and a reason causing the behavior is marked according to the classification, thereby reducing costs of manual marking and alleviating the problem of limitations of the human field of view. In addition, an obtained driving scene understanding result may be used for classifying and marking training data, to train a track planning model, so that the self-driving device may be better applied to service fields such as logistics and take-out delivery. The present disclosure is described in detail below with reference to specific embodiments.

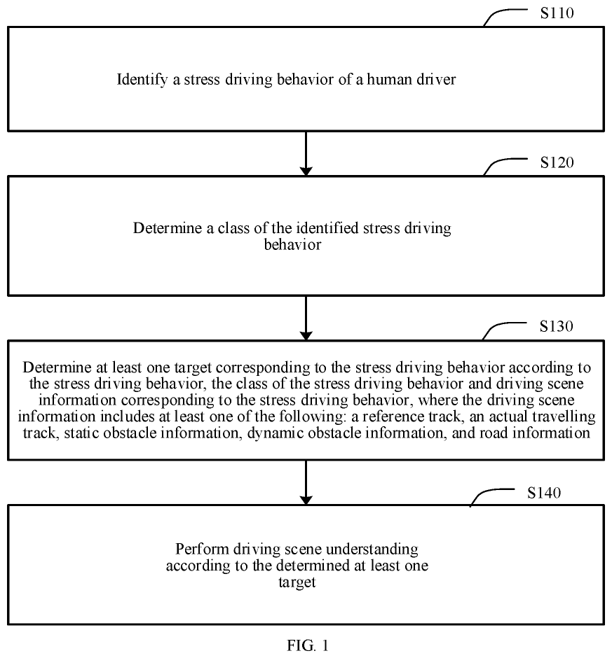

FIG. 1 is a schematic flowchart of a driving scene understanding method according to an embodiment of the present disclosure. The driving scene method is applicable to a neural network and is implemented by a processor in a self-driving device. As shown in FIG. 1, the driving scene understanding method includes the following steps S110 to S140.

At step S110, identify a stress driving behavior of a human driver.

A stress behavior refers to a purposive reaction generated when a living body can accept an external stimulus, and in the embodiments of the present disclosure, mainly refers to a driving behavior corresponding to a reaction generated when a human driver is stimulated by a target or information in a scene during driving, for example, stopping, car-following, or avoiding.

In a normal driving process, a human driver is usually not in a stress driving state for a long time. For example, at morning and evening rush hours, a traffic jam state may exist for a relatively long time to cause a relatively long time of car-following; and during driving on an expressway, a driving device may keep a straight traveling state for a long time. In the states, the driving behavior of the human driver is undiversified, and no stress driving behavior may be identified, or an identification effect is relatively poor. Therefore, when driving behavior data is to be obtained, data corresponding to this class of driving behavior may be excluded, thereby appropriately selecting a driving behavior.

At Step S120, determine a class of the identified stress driving behavior.

Stress driving behaviors such as stopping, car-following, and avoiding have different behavior features. According to differences among the behavior features, the stress driving behaviors may be classified into different classes. In this way, different classes of stress driving behaviors may be differently analyzed, to determine different targets to which attention needs to be paid in different driving scenes.

At Step S130, determine at least one target according to the identified stress driving behavior, the class of the stress driving behavior and driving scene information corresponding to the stress driving behavior, where the driving scene information includes at least one of the following: a reference track, an actual traveling track, static obstacle information, dynamic obstacle information, and road information.

In this embodiment, information such as the reference track or the actual traveling track is exemplarily described from a content dimension of the driving scene information, and specific information may be recorded in different forms. For example, an obstacle may be marked in an image, or road information may be recorded as an expressway, an urban road or the like by using structured data.

At Step S140, perform driving scene understanding according to the determined at least one target.

For example, using reversing as an example, a target such as a front or rear driving device or an obstacle that needs to be used as a reference may be identified from a driving scene corresponding to a stress driving behavior such as reversing, and driving scene understanding is performed based on the target. For a self-driving device, targets corresponding to various stress driving behaviors are surrounding driving scenes. The targets corresponding to the driving behaviors may comprehensively reflect the driving scenes of the self-driving device. A driving scene understanding result obtained in this embodiment of the present disclosure may be a state change of a target within a period of time, an effect on a driving behavior and the like.

In the driving scene understanding method shown in FIG. 1, the concept of stress is introduced into a driving scene understanding process. Therefore, effective learning is performed based on a driving behavior of a human driver, a stress driving behavior is identified and analyzed and a corresponding target is marked, thereby improving a scene understanding level of a self-driving device for a driving scene, facilitating track planning of the self-driving device, and ensuring smooth and safe traveling. The method may be relatively well applied to fields such as logistics and take-out delivery.

In an embodiment of the present disclosure, the identifying a stress driving behavior of a human driver includes: obtaining driving behavior data of the human driver in a time sequence, where the driving behavior data includes a velocity of a driving device and/or a steering angle of the driving device; and searching, by using a search network, the driving behavior data for partial driving behavior data having a first feature as stress driving behavior data.

FIG. 5 is a schematic structural diagram of a driving scene understanding network framework according to an embodiment of the present disclosure. Driving scene understanding may be jointly implemented with the help of a behavior network and an understanding network. In this embodiment of the present disclosure, the behavior network may include a search network 501, a classification network 502 and an attention network 503. The behavior network may be implemented through, for example, a convolutional neural network (CNN) 504, a recurrent neural network (RNN) or a long short-term memory (LSTM) network. The understanding network may further include the convolutional neural network 504 and the long short-term memory network 505. An input end of the behavior network may input driving behavior data. Because a velocity or a steering angle corresponding to a stress driving behavior such as stopping or lane changing has an evident feature, corresponding partial driving behavior data may be searched for as stress driving behavior data based on the feature.

From the perspective of digitization, because driving behavior data is generated in chronological order, a driving behavior B may be considered as a driving behavior in a time sequence. The driving behavior data may include a velocity v of a driving device, a steering angle θ of a steering wheel and the like. Driving behavior data in which the velocity v or the steering angle θ of the steering wheel conforms to a first feature may be found as stress driving behavior data by searching the driving behavior data by using the search network 501, and the first feature may be specifically a variation feature related to the velocity v, for example, a curvature change on a v-t curve corresponding to the driving behavior data; or a variation feature related to the steering angle θ of the steering wheel, for example, a curvature change on a θ-t curve corresponding to the driving behavior data. After the driving behavior B is inputted, the search network 501 may output a stress driving behavior Bₜ_{ₒ₋ₙ} occurring within a particular period of time in the driving behavior. For example, the search network 501 may classify, according to the variation features of v and θ in the driving behavior data, a stress driving behavior occurring during driving based on a time sequence, that is, a driving behavior within the time t₀₋ₙ, where t₀ is the start time of the stress driving behavior, and tₙ is the end time of the stress driving behavior.

In an embodiment of the present disclosure, the determining a class of the identified stress driving behavior includes: identifying a second feature of the stress driving behavior data by using the classification network 502, and marking the stress driving behavior data with a class label according to the identified second feature, where the class label indicates one of the following stress driving behaviors: stopping, car-following, overtaking and avoiding.

In some examples, the classification network 502 is a node network that may classify data according to data features. As shown in FIG. 5, the second feature of the stress driving behavior data may be identified by using the classification network 502, and the second feature may be a variation trend feature. For example, a stress driving behavior may be classified as one of classes such as stopping, car-following, overtaking and avoiding based on variation trends of v and θ in a driving behavior and be marked with a corresponding label. For example, a stress driving behavior having a feature that v constantly decreases until zero may be determined as stopping, and marked with a stopping label; a stress driving behavior having a feature that v quickly decreases to a specific value, then keeps relatively stable for a period of time and θ keeps unchanged may be determined as car-following, and marked with a car-following label; a stress driving behavior having a feature that v and θ first increase and then decrease within a short time may be determined as overtaking, and marked with an overtaking label; and a stress driving behavior having a feature that v suddenly decreases and then recovers to an initial value or θ suddenly changes, then reversely changes by the same value and finally recovers to an initial value may be determined as avoiding, and marked with an avoiding label. For example, when the stress driving behavior Bₜ_{₀₋ₙ} in a range from the start time t₀ to the end time tₙ is inputted, a stress driving behavior Bₜ_{₀₋ₙ}^{class} including classification information may be outputted, where class is a class label of the stress driving behavior.

In an embodiment of the present disclosure, determining at least one target according to the identified stress driving behavior, the class of the stress driving behavior and driving scene information corresponding to the stress driving behavior includes: performing, according to the class of the stress driving behavior, attention processing on the stress driving behavior by using the attention network 503; determining the at least one target based on the stress driving behavior on which the attention processing is performed and the driving scene information corresponding to the stress driving behavior, and performing a safe distance identification on each of the at least one target by using a responsibility sensitive safety circuit; and for a target corresponding to a safe distance less than a preset value, marking the target with an attention label.

The attention network 503 may selectively pay attention to a part of all information by using an attention mechanism, and meanwhile ignore other information, and therefore may perform corresponding attention processing on the driving data Dt₀₋ₙ according to a class of the stress driving behavior. The attention network 503 may calculate, by using a responsibility sensitive safety (RSS) circuit, a safe distance between the driving device and each target in a surrounding environment according to a current velocity v and/or a steering angle θ of the driving device. The RSS module is a model of defining a “safe state” in a mathematical manner to avoid an accident. A target corresponding to a distance less than the safe distance may be marked with an attention label Attention according to a distance outputted by the RSS module.

To better perform operation processing of early warning and risk avoiding on the stress driving behavior, a safe distance identification may be performed on each target in a driving scene corresponding to the stress driving behavior by using the RSS module. When an identified safe distance is less than a preset threshold, a corresponding target is marked with an attention label, to optimize an algorithm, thereby improving efficiency, accuracy and reliability of scene understanding.

During driving of a human driver, when a road condition changes or an environment around a driving device changes, the human driver conducts a stress behavior according to a driving scene, thereby quickly adjusting a driving state of the driving device. For example, in the car-following state, if the driving device is excessively close to a front driving device or is at an excessively high velocity relative to a front driving device, the human driver conducts a behavior of reducing the driving device velocity and increasing the distance from the front driving device to keep the safe distance. In this embodiment of the present disclosure, reference is made to a stress driving behavior conducted in a human driving process, the attention network and the responsibility sensitive safety circuit are introduced, and classes of different stress driving behaviors are correspondingly processed, to achieve a scene understanding objective.

In an embodiment of the present disclosure, performing, according to the class of the stress driving behavior, attention processing on the stress driving behavior by using an attention network includes at least one of the following: for a stress driving behavior of a stopping class, detect whether a traffic light exists in a traveling direction of the driving device, where if a traffic light exists, the traffic light is directly determined as a target and the traffic light is marked with an attention label, and if no traffic light exists, paying attention around the driving device; for a stress driving behavior of an overtaking class, paying attention in front of and beside the driving device; for a stress driving behavior of a car-following class, paying attention in front of the driving device; and for a stress driving behavior of an avoiding class, paying attention in front of, behind and beside the driving device.

For example, during stopping, the attention mechanism first detects a traffic light from a traveling direction of the driving device, where if a traffic light is detected, the traffic light is determined as a target and the target is marked with an attention label; and if no traffic light is detected, attention is paid around the driving device, and a safe distance from an object around the driving device is determined according to the RSS module, thereby marking the object within the safe distance. During overtaking, attention is paid in front of and beside the driving device, and the attention mechanism may determine safe distances from objects in front of and beside the driving device through the RSS module, and mark an object corresponding to a minimum safe distance of the determined safe distances. During car-following, attention is paid in front of the driving device, and the attention mechanism may determine safe distances from objects only in front of the driving device through the RS S module, and mark an object corresponding to a minimum safe distance of the determined safe distances. During driving device avoiding, attention is paid in front of, behind and beside the driving device, and the attention mechanism may determine safe distances from objects in front of, behind and beside the driving device through the RSS module, and mark an object corresponding to a minimum safe distance of the determined safe distances.

In an embodiment of the present disclosure, the driving scene information includes at least image frame information, and the performing driving scene understanding according to the determined at least one target includes: for each of the at least one target, extracting an image feature corresponding to the target by performing convolution processing on a plurality of image frames related to the target with the convolutional neural network 504; allocating, based on the image feature, a weight to each of the image frames with a long short-term memory network, and capturing, according to each of the image frames to which the weight is allocated, an action feature of the target with an optical flow method; and determining, based on the action feature of the target, semantic description information of the target as a driving scene understanding result.

The foregoing convolutional neural network is a type of feedforward neural network including convolutional computation and having a deep structure, and may perform learning on pixels and audios; and has a stable effect and has no additional feature engineering requirement for data.

The foregoing long short-term memory network is a time recurrent neural network, is suitable for processing and predicting important events with quite long intervals and delays in a time sequence, and may be used as a complex nonlinear unit. Therefore, a larger deep neural network may be constructed by using the long short-term memory network. The foregoing optical flow method may be used for describing movement of an observed target, surface or edge caused relative to movement of an observer. This method plays an important role in pattern identification, computer vision and other image processing fields, and is widely used for fields such as motion detection, object segmentation, time-to-collision and focus of expansion calculations, motion compensated coding, or stereo measurement performed through surfaces and edges of an object. As shown in FIG. 5, data outputted through processing of the search network 501, the classification network 502, and the attention network 503 in the behavior network may be used as input of the understanding network. The understanding network uses output of the behavior network as input, where the convolutional neural network 504 performs parallel convolution processing on different image frames, to extract image features corresponding to a target with an attention label Attention as input of the long short-term memory network 505. The long short-term memory network 505 allocates different weights to the image frames based on information such as the features and locations in images, and captures action features corresponding to the target with the attention label Attention with the help of the optical flow method. Final output of the entire understanding network is semantic descriptions corresponding to different targets with the attention label Attention. In this way, a driving scene is understood.

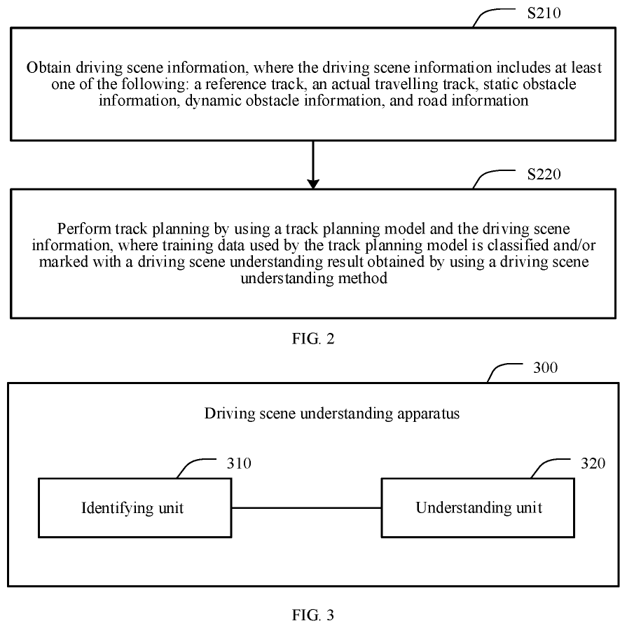

FIG. 2 is a schematic flowchart of a track planning method according to an embodiment of the present disclosure. The track planning method may be applied to a track planning module of a self-driving device and implemented by a processor. As shown in FIG. 2, the track planning method includes the following steps:

Step S210: obtain driving scene information, where the driving scene information includes at least one of the following: a reference track, an actual traveling track, static obstacle information, dynamic obstacle information, and road information.

Description is still made herein by using an example from the perspective of content, and various types of information may be uniformly fused into a designated map format to perform subsequent track planning.

For example, sensors of the self-driving device may capture image information, video information, distance information and the like of various objects around the self-driving device. By synthesizing the information captured by the sensors, a scene in which the self-driving device is located may be reflected, thereby providing a data basis for track planning of the self-driving device.

Step S220: perform track planning by using a track planning model and the obtained driving scene information, where training data used by the track planning model is classified and/or marked with a driving scene understanding result obtained by using the driving scene understanding method described in any one of the foregoing embodiments.

The foregoing driving scene understanding method provides classified and marked training data for training of the track planning model, so that a target does not need to be manually marked, thereby avoiding limitations of the human field of view and reducing manual costs. Moreover, a classification result considers the stress, so that track planning can learn a positive demonstration made by a human driver.

FIG. 3 is a schematic structural diagram of a driving scene understanding apparatus according to an embodiment of the present disclosure. As shown in FIG. 3, the driving scene understanding apparatus 300 includes the following units.

An identifying unit 310 is configured to identify a stress driving behavior of a human driver.

An understanding unit 320 is configured to determine a class of the identified stress driving behavior; determine at least one target according to the identified stress driving behavior, the class of the stress driving behavior and driving scene information corresponding to the stress driving behavior, where the driving scene information includes at least one of the following: a reference track, an actual traveling track, static obstacle information, dynamic obstacle information, and road information; and perform driving scene understanding according to the determined at least one target.

For example, using reversing as an example, a target such as a front or rear driving device or an obstacle that needs to be used as a reference may be identified from a driving scene corresponding to a stress driving behavior such as reversing, and driving scene understanding is performed based on the target. For a self-driving device, targets corresponding to various stress driving behaviors are surrounding driving scenes. The targets corresponding to the driving behaviors may comprehensively reflect the driving scenes of the self-driving device. A driving scene understanding result obtained in this embodiment of the present disclosure may be a state change of a target within a period of time, an effect on a driving behavior and the like.

It can be seen that, in the driving scene understanding apparatus shown in FIG. 3, the concept of stress is introduced into a driving scene understanding process. Therefore, effective learning is performed based on a driving behavior of a human driver, a stress driving behavior is identified and analyzed and a corresponding target is marked, thereby improving a scene understanding level of a self-driving device for a driving scene, facilitating track planning of the self-driving device, and ensuring smooth and safe traveling. The apparatus is relatively well applied to fields such as logistics and take-out delivery.

In an embodiment in accordance with the disclosure the present disclosure, the identifying unit 310 is configured to obtain driving behavior data of the human driver in a time sequence, where the driving behavior data includes a velocity of a driving device and a steering angle of the driving device; and search, by using a search network, the driving behavior data for partial driving behavior data having a first feature as stress driving behavior data.

In an embodiment in accordance with the present disclosure, the understanding unit 320 is configured to identify a second feature of the stress driving behavior data by using a classification network, and mark the stress driving behavior data with a class label according to the identified second feature, where the class label indicates one of the following stress driving behaviors: stopping, car-following, overtaking and avoiding.

In an embodiment in accordance with the present disclosure, the understanding unit 320 is configured to perform, according to the class of the stress driving behavior, attention processing on the stress driving behavior by using an attention network; determine the at least one target based on the stress driving behavior on which the attention processing is performed and the driving scene information corresponding to the stress driving behavior, and perform a safe distance identification on each of the at least one target by using a responsibility sensitive safety circuit; and for a target corresponding to a safe distance less than a preset value, mark the target with an attention label.

In an embodiment in accordance with the present disclosure, the understanding unit 320 is configured to, for a stress driving behavior of a stopping class, detect whether a traffic light exists in a traveling direction of the driving device, where if a traffic light exists, the traffic light is directly determined as a target and the traffic light is marked with an attention label, and if no traffic light exists, attention is paid around the driving device; for a stress driving behavior of an overtaking class, pay attention in front of and beside the driving device; for a stress driving behavior of a car-following class, pay attention in front of the driving device; and for a stress driving behavior of an avoiding class, pay attention behind and beside the driving device.

In an embodiment in accordance with the present disclosure, the driving scene information includes at least image frame information, and the understanding unit 320 is configured to: for each of the at least one target, extract an image feature corresponding to the target by performing convolution processing on a plurality of image frames related to the target with a convolutional neural network in the neural network; allocate based on the image feature, a weight to each of the image frames with a long short-term memory network in the neural network, and capture, according to each of the image frames to which the weight is allocated, an action feature of the target with an optical flow method; and determine, based on the action feature of the target, semantic description information of the target as a driving scene understanding result.

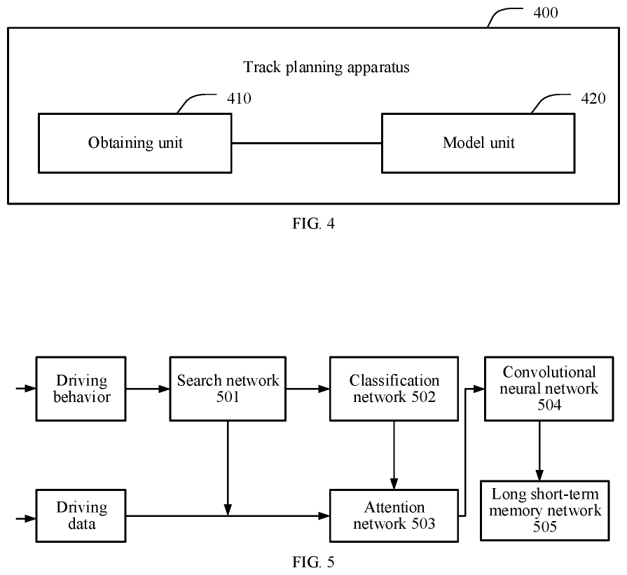

FIG. 4 is a schematic structural diagram of a track planning apparatus according to an embodiment of the present disclosure. The track planning apparatus may be applied to a track planning module of a self-driving device. As shown in FIG. 4, the track planning apparatus 400 includes the following units:

An obtaining unit 410 is configured to obtain driving scene information, where the driving scene information includes at least one of the following: a reference track, an actual traveling track, static obstacle information, dynamic obstacle information, and road information.

Description is still made herein by using an example from the perspective of content, and various types of information may be uniformly fused into a designated map format to perform subsequent track planning.

For example, sensors of the self-driving device may capture image information, video information, distance information and the like of various objects around the self-driving device. By synthesizing the information captured by the sensors, a scene in which the self-driving device is located may be reflected, thereby providing a data basis for track planning of the self-driving device.

A model unit 420 is configured to perform track planning by using a track planning model and the obtained driving scene information, where training data used by the track planning model is classified and/or marked with a driving scene understanding result obtained by using the driving scene understanding method described in any one of the foregoing embodiments.

The foregoing driving scene understanding apparatus provides classified and marked training data for training of the track planning model, so that a target does not need to be manually marked, thereby avoiding limitations of the human field of view and reducing manual costs. Moreover, a classification result considers the stress, so that track planning can learn a positive demonstration made by a human driver.

It should be noted that, example implementations of the foregoing apparatus embodiments may be performed with reference to example implementations of the foregoing corresponding method embodiments, and details are not described herein again.

It should be noted that, the algorithms and displays provided herein are not inherently related to any particular computer, virtual apparatus, or other device. Various general purpose apparatuses can also be used together with teaching set forth herein. In addition, the present disclosure is not directed to any particular programming language. It should be understood that the content of the present disclosure described herein may be implemented by using various programming languages and the above description of a particular language is to disclose an optimal implementation of the present disclosure.

Numerous details are set forth in the specification provided herein. However, it can be understood that, embodiments in accordance with the present disclosure may be practiced without some details described herein. In some examples, well-known methods and structures are not shown in detail not to obscure the understanding of this specification.

Similarly, it should be understood that in the foregoing description of exemplary embodiments in accordance with the present disclosure, various features of the present disclosure are sometimes grouped together into a single embodiment, a single figure, or description thereof, to simplify the present disclosure and assist in understanding one or more of various aspects of the present disclosure. However, the disclosed method should not be construed as reflecting the intention that the claimed disclosure requires more features than those explicitly recorded in each claim. More definitely, as reflected by the following claims, aspects of the present disclosure lie in being less than all features of a single embodiment disclosed above. Therefore, the claims following the Detailed Description are hereby expressly incorporated into the Detailed Description, with each claim standing on its own as a separate embodiment of the present disclosure.

Those skilled in the art can understand that the modules in the devices in the embodiments may be adaptively changed and disposed in one or more devices different from those of the embodiments. Modules or units or components in the embodiments may be combined into one module or unit or component, and in addition, they may be divided into a plurality of sub-modules or sub-units or sub-components. All features disclosed in the present disclosure (including the accompanying claims, abstract and drawings), and all processes or units of any method or device disclosed herein may be combined in any combination, unless at least some of such features and/or processes or units are mutually exclusive. Unless otherwise explicitly stated, each feature disclosed in the present disclosure (including the accompanying claims, abstract and drawings) may be replaced with an alternative feature serving the same, equivalent or similar purpose.

In addition, those skilled in the art can understand that, although some embodiments herein include some but not other features included in other embodiments, combinations of features of different embodiments are meant to be within the scope of the present disclosure and to form different embodiments. For example, in the following claims, any one of the claimed embodiments may be used in any combination.

The various component embodiments of the present disclosure may be implemented in hardware or in software modules running on one or more processors or in a combination thereof. Those skilled in the art should understand that a microprocessor or a digital signal processor (DSP) may be used in practice to implement some or all of the functions of some or all of the components of the driving scene understanding apparatus and the track planning apparatus according to the embodiments of the present disclosure. The present disclosure may also be implemented as a device or apparatus program (for example, a computer program and a computer program product) for performing part or all of the methods described herein. Such a program implementing the present disclosure may be stored on a computer-readable medium or may have the form of one or more signals. Such signals may be downloaded from Internet websites, provided on carrier signals, or provided in any other form.

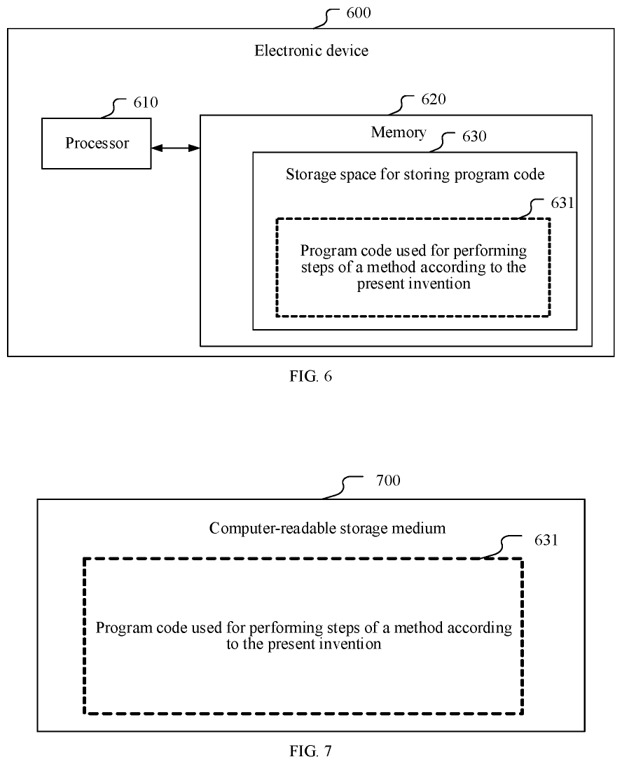

For example, FIG. 6 is a schematic structural diagram of an electronic device according to an embodiment of the present disclosure. The electronic device 600 includes a processor 610 and a memory 620 configured to store instructions (computer-readable program code) that may be executed by the processor. The memory 620 may be an electronic memory such as a flash memory, an electrically erasable programmable read-only memory (EEPROM), an EPROM, a hard disk or a ROM. The memory 620 has a storage space 630 storing computer-readable program code 631 used for performing any method step in the foregoing method. For example, the storage space 630 used for storing computer-readable program code may include pieces of computer-readable program code 631 used for implementing various steps in the foregoing method. When the computer-readable program code 631 implements a track planning method for a self-driving device, the electronic device 600 may be specifically the self-driving device. The computer-readable program code 631 may be read from one or more computer program products or be written to the one or more computer program products. The computer program products include a program code carrier such as a hard disk, a compact disc (CD), a storage card or a floppy disk. Such a computer program product is usually, for example, a computer-readable storage medium described in FIG. 7. FIG. 7 is a schematic structural diagram of a non-transitory computer-readable storage medium according to an embodiment of the present disclosure. The computer-readable storage medium 700 stores computer-readable program code 631 used for performing method steps according to the present disclosure, and may be read by the processor 610 of the electronic device 600. When the computer-readable program code 631 is run by the electronic device 600, the electronic device 600 is caused to perform steps of the foregoing method. Specifically, the computer-readable program code 631 stored in the computer-readable storage medium may perform a method shown in any one of the foregoing embodiments. The computer-readable program code 631 may be compressed in an appropriate form.

It should be noted that the above-mentioned embodiments illustrate rather than limit the present disclosure, and those skilled in the art may devise alternative embodiments without departing from the scope of the appended claims. In the claims, any reference signs placed between parentheses shall not be construed as limiting the claims. The word “comprise” does not exclude the presence of elements or steps not listed in the claims. The word “a” or “an” preceding an element does not exclude the presence of a plurality of such elements. The present disclosure can be implemented by way of hardware including several different elements and an appropriately programmed computer. In the unit claims enumerating several apparatuses, several of these apparatuses can be specifically embodied by the same item of hardware. The use of the words such as “first”, “second”, “third”, and the like does not denote any order. These words can be interpreted as names.

1. A driving scene understanding method, being applicable to a neural network, wherein the driving scene method is implemented by a processor in a self-driving device such that the processor is caused to perform the following operations:
identifying a stress driving behavior of a human driver;
determining a class of the identified stress driving behavior;
determining at least one target according to the identified stress driving behavior, the class of the stress driving behavior and driving scene information corresponding to the stress driving behavior, wherein the driving scene information comprises at least one of the following: a reference track, an actual traveling track, static obstacle information, dynamic obstacle information, and road information; and
performing driving scene understanding according to the determined at least one target.

2. The method according to claim 1, wherein identifying the stress driving behavior of a human driver comprises:
obtaining driving behavior data of the human driver in a time sequence, wherein the driving behavior data comprises a velocity of a driving device and a steering angle of the driving device; and
searching, by using a search network in the neural network, the driving behavior data for partial driving behavior data having a first feature as stress driving behavior data.

3. The method according to claim 2, wherein the first feature comprises features regarding change amount in the velocity and the steering angle of the driving device.

4. The method according to claim 2, wherein determining the class of the identified stress driving behavior comprises:
identifying a second feature of the stress driving behavior data by using a classification network in the neural network, and
marking the stress driving behavior data with a class label according to the identified second feature, wherein
the class label comprises at least one of the following: stopping, car-following, overtaking and avoiding.

5. The method according to claim 4, wherein the second feature comprises features regarding change trend in the velocity and the steering angle of the driving device.

6. The method according to claim 1, wherein determining the at least one target according to the identified stress driving behavior, the class of the stress driving behavior and driving scene information corresponding to the stress driving behavior comprises:
performing, by using an attention network in the neural network, attention processing on the stress driving behavior according to the class of the stress driving behavior;
determining the at least one target based on the stress driving behavior on which the attention processing is performed and the driving scene information corresponding to the stress driving behavior;
performing a safe distance identification on each of the at least one target by using a responsibility sensitive safety circuit; and
for a target corresponding to a safe distance less than a preset value, marking the target with an attention label.

7. The method according to claim 6, wherein performing, according to the class of the stress driving behavior, the attention processing on the stress driving behavior by using the attention network comprises:
for a stress driving behavior of a stopping class,
detecting whether a traffic light exists in a traveling direction of the driving device, wherein
in response to that a traffic light exists, determining the traffic light as the target and marking the traffic light with the attention label; and
in response to that no traffic light exists, paying attention around the driving device.

8. The method according to claim 7, further comprising at least one of the following:
for a stress driving behavior of an overtaking class, paying attention in front of and beside the driving device;
for a stress driving behavior of a car-following class, paying attention in front of the driving device; and
for a stress driving behavior of an avoiding class, paying attention in front of, behind and beside the driving device.

9. The method according to claim 1, wherein the driving scene information comprises at least image frame information, and the performing driving scene understanding according to the determined at least one target comprises:
for each of the at least one target,
extracting an image feature corresponding to the target by performing convolution processing on a plurality of image frames related to the target with a convolutional neural network (CNN) in the neural network;
allocating, based on the image feature, a weight to each of the image frames with a long short-term memory (LSTM) network in the neural network,
capturing, according to each of the image frames to which the weight is allocated, an action feature of the target with an optical flow method; and
determining, based on the action feature of the target, semantic description information of the target as a driving scene understanding result.

10. A track planning method, applied to a track planning module of a self-driving device, the method being implemented by a processor and comprising:
obtaining driving scene information, wherein the driving scene information comprises at least one of the following: a reference track, an actual traveling track, static obstacle information, dynamic obstacle information, and road information; and
performing track planning by using a track planning model and the obtained driving scene information, wherein training data used by the track planning model is classified and/or marked with a driving scene understanding result obtained by using the method according to claim 1.

11. An electronic device, comprising:
a processor; and
a memory to store instructions executable to the processor,
wherein when the instructions are executed, the processor is caused to implement the following operations:
identifying a stress driving behavior of a human driver;
determining a class of the identified stress driving behavior;
determining at least one target according to the identified stress driving behavior, the class of the stress driving behavior and driving scene information corresponding to the stress driving behavior, wherein the driving scene information comprises at least one of the following: a reference track, an actual traveling track, static obstacle information, dynamic obstacle information, and road information; and
performing driving scene understanding according to the determined at least one target.

12. The electronic device according to claim 11, wherein the identifying a stress driving behavior of a human driver comprises:
obtaining driving behavior data of the human driver in a time sequence, wherein the driving behavior data comprises a velocity of a driving device and/or a steering angle of the driving device; and
searching, by using a search network, the driving behavior data for partial driving behavior data having a first feature as stress driving behavior data.

13. The electronic device according to claim 11, wherein the first feature comprises features regarding variations in the velocity and the steering wheel of the driving device.

14. The electronic device according to claim 12, wherein the determining a class of the identified stress driving behavior comprises:
identifying, by using a classification network in a neural network, a second feature of the stress driving behavior data, and marking the stress driving behavior data with a class label according to the identified second feature, wherein
the class label comprises at least one of the following: stopping, car-following, overtaking and avoiding.

15. The electronic device according to claim 14, wherein the second feature comprises features regarding variation trend in the velocity and the steering angle of the driving device.

16. The electronic device according to claim 11, wherein determining the at least one target corresponding to the stress driving behavior according to the identified stress driving behavior, the class of the stress driving behavior and driving scene information corresponding to the stress driving behavior comprises:
performing, by using an attention network in a neural network, attention processing on the stress driving behavior according to the class of the stress driving behavior;
determining the at least one target based on the stress driving behavior on which the attention processing is performed and the driving scene information corresponding to the stress driving behavior, and performing a safe distance identification on each of the at least one target by using a responsibility sensitive safety circuit; and
for a target corresponding to a safe distance less than a preset value, marking the target with an attention label.

17. The electronic device according to claim 16, wherein the performing, according to the class of the stress driving behavior, attention processing on the stress driving behavior by using an attention network comprises:
for a stress driving behavior of a stopping class,
detecting whether a traffic light exists in a traveling direction of the driving device, wherein
in response to that a traffic light exists, determining the traffic light as the target and marking the traffic light with the attention label; and
in response to that no traffic light exists, paying attention around the driving device.

18. The electronic device according to claim 17, wherein performing, according to the class of the stress driving behavior, the attention processing on the stress driving behavior by using the attention network further comprises at least one of the following:
for a stress driving behavior of an overtaking class, paying attention in front of and beside the driving device;
for a stress driving behavior of a car-following class, paying attention in front of the driving device; and
for a stress driving behavior of an avoiding class, paying attention in front of, behind and beside the driving device.

19. The electronic device according to claim 12, wherein the driving scene information comprises at least image frame information, and the performing driving scene understanding according to the determined at least one target comprises:
for each of the at least one target,
extracting an image feature corresponding to the target by performing convolution processing on a plurality of image frames related to the target with a convolutional neural network (CNN) in the neural network;
allocating, based on the image feature, a weight to each of the image frames with a long short-term memory (LSTM) network in the neural network;
capturing, according to each of the image frames to which the weight is allocated, an action feature of the target with an optical flow method; and
determining, based on the action feature of the target, semantic description information of the target as a driving scene understanding result.

20. A non-transitory computer-readable storage medium, storing computer-readable program code, wherein when the computer-readable program code is executed by a processor, the processor is caused to implement the following operations:
identifying a stress driving behavior of a human driver;
determining a class of the identified stress driving behavior;
determining at least one target corresponding to the stress driving behavior according to the identified stress driving behavior, the class of the stress driving behavior and driving scene information corresponding to the stress driving behavior, wherein the driving scene information comprises at least one of the following: a reference track, an actual traveling track, static obstacle information, dynamic obstacle information, and road information; and
performing driving scene understanding according to the determined at least one target.
